(19) United States
(12) Patent Application Publication
(10) Pub. No.: US 2011/0063439 A1
(43) Pub. Date: Mar. 17, 2011

(54) METHOD FOR IDENTIFYING ANOMALIES IN OBJECT STREAMS USING THE PHENOMENON OF GROUP SPEED

(76) Inventors: Wolfram Klein, Neubiberg (DE); Gerta Köster, Munchen (DE)

(21) Appl. No.: 12/994,593

(22) PCT Filed: Apr. 14, 2009
(86) PCT No.: PCT/EP09/54372

§ 371 Date: Nov. 24, 2010

(30) Foreign Application Priority Data
May 29, 2008 (DE) 10-2008-025753.2.

(51) Int. Cl. H04N 7/18; G06F 19/00; G01P 3/00

(52) U.S. Cl. 348/142; 702/19; 702/142; 348/E07.085

(57) ABSTRACT

In a method and an apparatus for identifying, measuring and assessing anomalies in the behaviour of streams of people or objects, anomalies are identified, measured and assessed reliably and in all of their possible forms. At least one group in a stream of people or objects is statically identified at a particular time, the group is observed in a time profile, the group speed is measured and the streams of people or objects are assessed using the group speed. Various methods for detecting the group speed and various cases for assessing the group speed are shown. The method and apparatus is suitable for observing object streams in order to prevent accidents, for example.

### CROSS-REFERENCE TO RELATED APPLICATIONS

This application is a U.S. National Stage Application of International Application No. PCT/EP2009/054372 filed Apr. 14, 2009, which designates the United States of America, and claims priority to DE Application No. 10 2008 025 753.2 filed May 29, 2008. The contents of which are hereby incorporated by reference in their entirety.

### TECHNICAL FIELD

The present invention relates to a method for identifying, measuring and assessing anomalies in the behavior of streams of people or objects based on group speed, in other words the propagation speed of compressions in streams of people or objects.

### BACKGROUND

Anomalies in the behavior of streams of people and objects are not always identified reliably or in all their possible different forms. For example no distinction is made between stationary and traveling jams and the formation of new jams or the merging of existing jams is also not identified. There is an absence of both automatic identification criteria and assessment criteria.

Conventionally jams or the formation of compressions in streams of people or even other object streams are identified as follows at the present time. Identification takes place a) by way of the identification of compressions, in other words distances between objects or the number of objects per surface area compared with normal densities; b) by way of the difference between the speed of the individual objects and normal speed. With both methods further aspects such as the size of the evaluation region and the homogeneity of the human mass in said region are of relevance.

The prior art overlooks the following phenomenon. The speed of the individual objects does not have to correspond to the speed at which the compression moves. This speed of the compression is referred to as group speed according to the present application. According to the application a group refers to a dense accumulation of objects of the same type, for example people, automobiles, cows, baggage and the like. There does not have to be any further link between the objects. For example a jam is such a group, being a dense accumulation of automobiles. A jam can be present for a long time at the same point, for example roadworks, being almost stationary, while the individual automobiles move, even though such movement may be slow. Here the group speed, which is zero, in other words the speed of the (stationary) jam, differs from the speed of the individual objects, which is greater than zero. Even in a traveling jam, caused for example by a slow automobile, the group speed, which corresponds essentially to that of the slow automobile, can differ from the object speed, it being possible for the object speed to be the speed of an overtaking vehicle.

### SUMMARY

According to various embodiments, a method and an apparatus for identifying, measuring and assessing anomalies in the behavior of streams of people or objects can be specified so that anomalies can be identified, measured and assessed reliably and in all of their possible different forms.

According to an embodiment, an apparatus for implementing a method for the automated identification, measurement and assessment of anomalies in the behavior of streams of people or objects based on data from a plurality of sensors, data sources and/or surveillance cameras, may have—sensors, data sources and/or surveillance cameras for the stationary identification of at least one group in a stream of people or objects at a specific time;—sensors, data sources and/or surveillance cameras for observing the group in a time profile;—sensors, data sources and/or surveillance cameras for measuring group speed; and—a data assessment facility for assessing group speed.

According to a further embodiment, a group can be a region with a higher density than its surroundings and group association is determined by means of a minimum density. According to a further embodiment, in the case of group association a person or object can be assigned to a group list so that the group then consists of the individual people or individual objects in the group region. According to a further embodiment, the apparatus may further comprise definition of the periphery of the group by means of a polyline. According to a further embodiment, where there are a multiplicity of subgroups, these can be assigned identifiers and/or group characteristics, for example size of group in people or objects, surface area in meters, expansion in one direction, expansion ratio, group core, location and value of local density minima, peripheral behavior, in particular drop in density, speeds and/or homogeneity. According to a further embodiment, observation may take place by means of assigning the identified subgroups to the subgroups identified in the past by means of assignment of the subgroups over time based on the identifiers and/or group characteristics and a breaking up or merging of subgroups is identified. According to a further embodiment, the apparatus may further comprise measurement of the group speed by detecting a change in the position of a density maximum of the group related to a time change. According to a further embodiment, the apparatus may further comprise measuring the group speed by detecting a change in the position of a center of mass of the group expansion related to a time change. According to a further embodiment, the apparatus may further comprise measuring the group speed by detecting speeds of peripheral points of the group. According to a further embodiment, the apparatus may further comprise measuring the group speed by detecting speeds of end points of at least one expansion of the group in at least one preferred direction. According to a further embodiment, the apparatus may further comprise measuring the group speeds of delimitable subgroups in a group. According to a further embodiment, the apparatus may further comprise measuring the speeds of people or objects in the subgroups. According to a further embodiment, the apparatus may further comprise assessing by comparing the speeds of the group as a whole, the subgroups, the people or objects in the subgroups and/or the mean speed from the individual speeds. According to a further embodiment, the apparatus may further comprise assessing by comparing the group speed of the group as a whole with the speed of the associated people or objects and/or with the mean speed from the individual speeds. According to a further embodiment, the apparatus may further comprise assessing by comparing the group speeds of subgroups with the speeds of the respectively associated people or objects and/or with the mean speed from the individual speeds. According to a further embodiment, the apparatus may further comprise assessing by taking into account the onward movement directions of subgroups. According to a further embodiment, the apparatus may further comprise assessing by taking into account rhythmically changing group speeds and/or directions. According to a further embodiment, the apparatus may further comprise responding to an identified anomaly and/or impact on the group.

### BRIEF DESCRIPTION OF THE DRAWINGS

The present invention is described in more detail below with reference to examples in conjunction with figures, in which:

FIGS. 1A and 1B show an exemplary embodiment of an object stream;

FIGS. 2A and 2B show a second example of an object stream.

### DETAILED DESCRIPTION

According to the various embodiment a group speed is provided as the essential feature.

According to various embodiments, a method and an apparatus for identifying, measuring and assessing anomalies in streams of objects, for example streams of people, based on group speed, in other words the propagation speed of compressions in streams of objects, for example streams of people. Some embodiments also provide for a method for measuring group speed.

A group is defined as a compression. A group speed is defined as the propagation speed of such a compression.

The group speed according to various embodiments has an analogy in the theory of the superposition of harmonic waves, in which a distinction is made between the propagation speed of an individual wave crest and the speed of wave groups, which corresponds to the group speed. The name group speed according to the present application is based on the wave theory term.

According to various embodiments anomalies are identified in the streams of objects, for example streams of people, the extent of the anomaly is measured, impacts of the anomaly are assessed and options for intervening in the streams of objects are thus created.

It is possible to use the group speed and in particular when this differs from speeds of the individual objects, or even mean speeds, to draw conclusions about the observed situation. To this end a) the group speed is measured first, different methods being claimed according to the present application for measuring group speeds. Then b) the group speed is used to identify, measure and assess anomalies in streams of objects.

It is not possible to measure group speed using the usual methods for determining speed, for example tracing group members, determining the speed of the individual people and then forming a mean, as the group speed does not have to correspond to the individual speed of a person in the group. For example in the case of a stationary jam the group speed may be zero, while the individual speeds may be greater than zero. The measurement of group speed is made all the more difficult as groups break up and reform.

According to one embodiment automated identification, measurement and assessment take place based on data from a plurality of sensors, data sources and/or surveillance cameras. According to this embodiment measurable variables are automatically introduced to allow conclusions to be drawn about interesting, in particular dangerous situations, which occur in accumulations of people, animals or objects. A method is provided for identifying, measuring and assessing anomalies in streams of objects and people, which can be used in many locations simultaneously and without a high personnel outlay. Of particular advantage is the evaluation of data from a plurality of sensors and data sources, for example surveillance cameras. According to this embodiment quantities of data provided by the sensors, which are in particular surveillance cameras, can be made usable.

According to one further embodiment a group is a region with a higher density than its surroundings and group association is determined by means of a minimum density. In other words a group is identified initially by way of an increased density. A group is a region with a higher density than its surroundings. The overall group or all the subregions of the group must have a higher density than their surroundings. The definition of a minimum density here is a precondition for group association. To identify densities it is possible to use density measurement algorithms, for example head counts, in the field of pattern recognition/video analysis.

According to one further embodiment in the case of group association a person or object is assigned to a group list so that the group then consists of the individual people or individual objects in the group region. In other words it is also useful to define the association of an individual person with a group. The group is defined as the region of expansion of a certain minimum density. A person or object is associated with the group if it is located in the region of expansion of the group. This person or object is then added to a group list. A group then consists of the individual people or objects in the group region.

According to one further embodiment the periphery of the group is defined for example by polyline. In other words the periphery of the group is calculated or defined for example by means of a polyline, a polyline being the quantity of points or the edges connecting these. It is possible to delimit the group from its surroundings in this simple manner.

According to one further embodiment a number of groups can also be identified in the overall region under examination. In other words a group features a plurality of subgroups. Such subgroups are separated by regions of local density minima, in other words regions of lower density than in the subgroup. Such subgroups have to be identified. Just as subgroups have to be identified, so also must the breaking up and reformation of new subgroups be allowed. This is achieved in that where there are a multiplicity of subgroups, these are assigned an identifier and/or group characteristics, for example size of group in people or objects, surface area in meters, expansion in one direction, expansion ratio, group core, location and value of local density minima, peripheral behavior, in particular drop in density, speeds and/or homogeneity. When identifying a group it is possible for example to assign unique names. An analysis/assignment of group characteristics is achieved for example by way of size of group in people, surface area in meters, expansion in one direction, expansion ratio, position, location of density maximum, which is the core of the group, location and value of local minima and the like. Further group characteristics are peripheral behavior, in other words a marked or weak drop in density, speed, in other words minimum and maximum values, and group homogeneity.

According to one further embodiment the group or subgroups is/are monitored by assignment of the identified groups to groups identified in the past by assigning the groups over time based on identifiers and/or group characteristics. An assignment of the identified groups to groups identified in the past, in other words monitoring of the groups in the time profile, is simple if only one group has to be monitored. If there is more than one group, it is necessary to use a decision tree, based on assignment of the groups over time based on identifiers and/or the abovementioned group characteristics. The breaking up or merging of subgroups is identified in this manner.

According to one further embodiment group speed is measured by detecting a change in the position of a density maximum of the group related to a time change. Such a method is based on a local density maximum. The local density maximum of the group must be found and is traced over time. The determined group speed is thus equal to the delta of the position of the density maximum in relation to the delta of time.

According to one further embodiment group speed is measured by detecting a change in the position of a center of mass of group expansion related to a time change. Such a method is based on the center point or center of mass of the expansion of the group. Group expansion here is determined for example by the periphery of the group for example by means of a polyline. The center point or center of mass of the polygon is then determined. In the case of irregular regions a convex envelope is used to determine the center point or center of mass.

According to one further embodiment group speed is measured by detecting speeds of peripheral points of the group. Such a method is based on the group periphery. To this end the periphery of the group is determined for example by means of a polyline or points. The peripheral points of the group are then assigned to one another over time. This allows the speed of the peripheral points to be determined. Such a method provides detailed different speeds at different peripheral points.

According to one further embodiment group speed is measured by detecting speeds of end points of at least one group expansion in at least one preferred direction. Such a method is based on the flat two-dimensional expansion of the group. First the expansion of the group is determined in one or more preferred directions, for example the horizontal or vertical direction. The start and end points of the respective expansions are then determined in the preferred directions. A speed determination is then carried out for these end points. Such a method provides detailed different speeds in the preferred directions.

According to the present application therefore different measurement methods are provided to detect group speed.

According to one further embodiment group speeds of delimitable subgroups in a group are measured. The group speeds of subgroups in a group are thus defined and analyzed. A group can break down into delimitable subgroups. A subgrouping can be provided by clustering speeds. It is also possible to define subgroups. A subgroup can be considered individually.

According to one further embodiment speeds of people or objects in the subgroups are measured. In other words a consideration of the individual speeds, i.e. the object speeds of the group elements or subgroup elements, can be advantageous.

According to one further embodiment assessment is performed by comparing the speeds of the group as a whole, the subgroups and/or the people or objects in the subgroups. In other words it is particularly advantageous to compare the individual/object and group speeds for subgroups and between subgroups. A group can break down into delimitable subgroups, for which an individual consideration and consideration compared with the group as a whole are expedient.

According to one further embodiment assessment is performed by comparing the group speed of the group as a whole with the speed of the associated people or objects. In other words the measurement of group speed is assessed in particular compared with the individual speeds, in other words the speeds of the individual people or objects. The measurement of group speed can likewise be assessed compared with the mean speed from the individual speeds. From the comparison of individual speeds or the mean speed with the group speed it is possible to carry out monitoring and control tasks. A comparison produces the following instance distinctions:

a) Group speed=individual speed. If the group speed largely corresponds to the individual speed, in other words in the context of slight fluctuations, these are individuals, objects that are moving forward at the same rate. It is a column of vehicles or a troop for example. In the non-military context in particular it can be a clear indication of aggressors, for example an attacking cycle team in a race, but also criminal aggressors, for example a paramilitary gang at a public event. If the individual speeds fluctuate more, it would be typical behavior for a demonstration.

b) Group speed is between minimum and maximum individual speed. This instance occurs for example in a marathon or cycle race, where the field separates slowly with fast runners taking the lead and weak runners falling behind. In the case of a cycle race an attacking team moving at the same speed would again appear as a subgroup (corresponding to instance a)). There are flowing transitions between instances a) and b) in their pure form. Suitable threshold values for permissible deviations of the individual speeds from the group speed can be determined from practice based on experience to identify groups moving at the same rate correctly.

c) Group speed is slower than individual speed. One extreme instance is when group speed is equal to zero and lower than individual speed. This instance indicates a jam. In an extreme instance the jam is stationary at a specific point, in other words the group speed is equal to zero, while the individuals, objects or people continue to move, in other words the individual speeds are greater than zero. It is thus possible for example to identify a jam caused by an accident. The compression occurs at the accident site and then dissolves quickly afterwards. Individual vehicles brake for example but generally continue to move.

According to one further advantageous embodiment assessment is performed by comparing the group speeds of subgroups with the speeds of the respectively associated people or objects. In other words for the observation and monitoring of a group the identification of subgroups and their respective group speeds is advantageous. Thus for example with a procession the group of onlookers at the procession can be determined using the comparisons described above. The subgroup procession here is characterized by the instance a). The group speed is identical to the individual speeds, with only slight differences between the individual speeds and the group speed. The subgroup onlookers corresponds to instance b), where the group speed is zero and the individual speed is greater than the group speed.

According to one further embodiment assessment is performed by taking into account the onward movement directions of subgroups, in other words the onward movement direction of subgroups is taken into account. One anomaly here is if the movement direction of a subgroup differs from that of the main group or the group around the subgroup. This could indicate aggression or violence in a crowd of people. A further example is an attack from one side by a pride of lions on a herd of gnu.

According to one further embodiment assessment is performed by taking into account rhythmically changing group speeds and/or directions. Rhythmically changing group speeds and/or directions can likewise indicate violence. One example is the rhythmic forward and backward movement of a crowd when storming a fence when violence breaks out in a football stadium.

According to one further embodiment there is a response to an identified anomaly and/or an impact on a group.

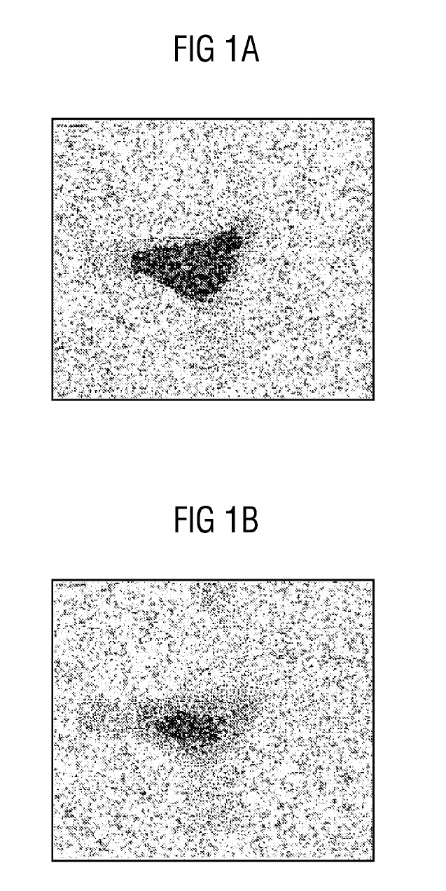

FIG. 1 shows a first exemplary embodiment of an object stream. FIG. 1 shows a stationary jam at a junction. The group (dark dots) moves at group speed zero, while the individual people proceed at a low speed greater than zero. Different behavior of people at the periphery of the jam is also shown: FIG. 1a shows a sharp periphery. FIG. 1b shows a looser periphery.

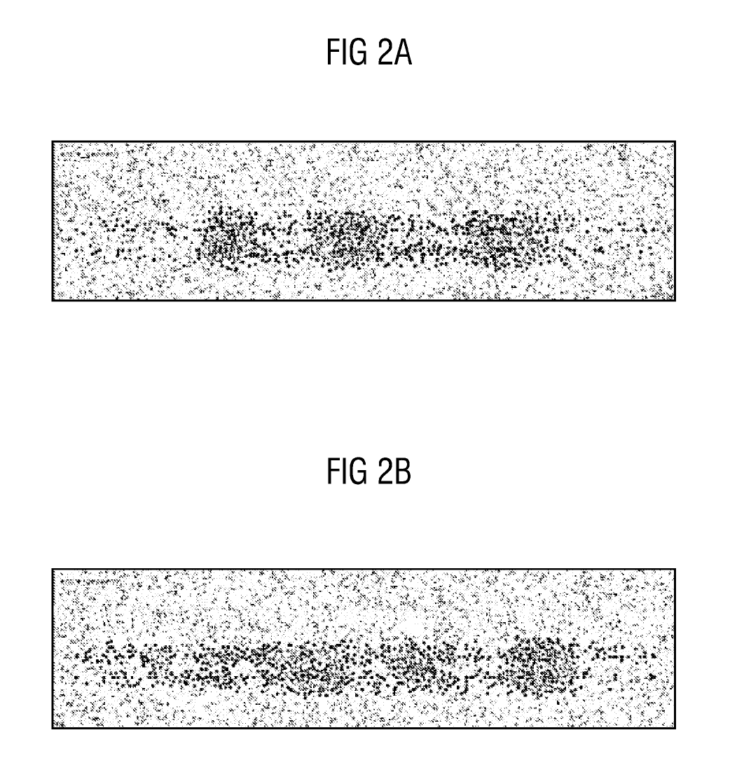

FIG. 2 shows a second exemplary embodiment of an object stream. FIG. 2 shows a jam formation with a number of identifiable groups, i.e. subgroups, the group speed being greater than zero and the group speed being lower than the speed of the individuals. The subgroups continue to move, break down, merge into one another. Jam formation is caused by random events, such as the random stopping of one person, stumbling or window shopping. FIG. 2a shows the group as a whole at a first time and FIG. 2b shows the group as a whole at a second time.

What is claimed is:

1. An apparatus for implementing a method for the automated identification, measurement and assessment of anomalies in the behavior of streams of people or objects based on data from a plurality of sensors, data sources and/or surveillance cameras, comprising
at least one of sensors, data sources and surveillance cameras for the stationary identification of at least one group in a stream of people or objects at a specific time;
at least one of sensors, data sources and surveillance cameras for observing the group in a time profile;
at least one of sensors, data sources and surveillance cameras for measuring group speed; and
a data assessment facility for assessing group speed.

2. The apparatus according to claim 1, wherein a group is a region with a higher density than its surroundings and group association is determined by means of a minimum density.

3. The apparatus according to claim 2, wherein in the case of group association a person or object is assigned to a group list so that the group then consists of the individual people or individual objects in the group region.

4. The apparatus according to claim 1, comprising definition of the periphery of the group by means of a polyline.

5. The apparatus according to claim 1, wherein where there are a multiplicity of subgroups, these are at least one of assigned identifiers and group characteristics.

6. The apparatus according to claim 5, wherein observation takes place by means of assigning the identified subgroups to the subgroups identified in the past by means of assignment of the subgroups over time based on the at least one of identifiers and group characteristics and a breaking up or merging of subgroups is identified.

7. The apparatus according to claim 1, wherein the apparatus is operable to measure the group speed by detecting a change in the position of a density maximum of the group related to a time change.

8. The apparatus according to claim 1, wherein the apparatus is operable to measure the group speed by detecting a change in the position of a center of mass of the group expansion related to a time change.

9. The apparatus according to claim 1, wherein the apparatus is operable to measure the group speed by detecting speeds of peripheral points of the group.

10. The apparatus according to claim 1, wherein the apparatus is operable to measure the group speed by detecting speeds of end points of at least one expansion of the group in at least one preferred direction.

11. The apparatus according to claim 1, wherein the apparatus is operable to measure the group speeds of delimitable subgroups in a group.

12. The apparatus according to claim 1, wherein the apparatus is operable to measure the speeds of people or objects in the subgroups.

13. The apparatus according to claim 1, wherein the apparatus is operable to assess by comparing the speeds of the group as a whole, the subgroups, the people or objects in the at least one of subgroups and the mean speed from the individual speeds.

14. The apparatus according to claim 1, wherein the apparatus is operable to assess by comparing the group speed of the group as a whole with at least one of the speed of the associated people or objects and with the mean speed from the individual speeds.

15. The apparatus according to claim 1, wherein the apparatus is operable to assess by comparing the group speeds of subgroups with at least one of the speeds of the respectively associated people or objects and with the mean speed from the individual speeds.

16. The apparatus according to claim 1, wherein the apparatus is operable to assess by taking into account the onward movement directions of subgroups.

17. The apparatus according to claim 1, wherein the apparatus is operable to assess by taking into account at least one of rhythmically changing group speeds and directions.

18. The apparatus according to claim 1, wherein the apparatus is operable to respond to at least one of an identified anomaly and impact on the group.

19. The apparatus according to claim 5, wherein the at least one of assigned identifiers and group characteristics are selected from the group consisting of: size of group in people or objects, surface area in meters, expansion in one direction, expansion ratio, group core, location and value of local density minima, peripheral behavior, drop in density, speeds and homogeneity.

20. A method for the automated identification, measurement and assessment of anomalies in the behavior of streams of people or objects based on data from a plurality of sensors, data sources and/or surveillance cameras, comprising
stationary identifying of at least one group in a stream of people or objects at a specific time by said at least one of sensors, data sources and surveillance cameras;
observing the group in a time profile by said at least one of sensors, data sources and surveillance cameras;
measuring group speed by said at least one of sensors, data sources and surveillance cameras; and
assessing the group speed.
